(19) United States
(12) Patent Application Publication
(10) Pub. No.: US 2024/0372892 A1
(43) Pub. Date: Nov. 7, 2024

(54) SYSTEMS AND METHODS TO REDIRECT DDOS ATTACK USING REMOTE MITIGATION TOOLS

(71) Applicant: CenturyLink Intellectual Property LLC, Denver, CO (US)

(72) Inventors: Dean Ballew, Sterling, VA (US); John R.B. Woodworth, Amissville, VA (US)

(73) Assignee: CenturyLink Intellectual Property LLC, Denver, CO (US)

(21) Appl. No.: 18/631,514

(22) Filed: Apr. 10, 2024

Related U.S. Application Data
(60) Provisional application No. 63/499,865, filed on May 3, 2023.

(51) Int. Cl. H04L 9/40; H04L 45/74; H04L 61/4511

(52) U.S. Cl. CPC H04L 63/1458; H04L 45/74; H04L 61/4511; H04L 63/0236

(57) ABSTRACT

Distributed denial of service (DDOS) attacks may occur in various networks and may target any of various servers. A DDOS attack on a server in a first autonomous system may be launched from within another autonomous system, or from within the same autonomous system. Some autonomous systems may include threat mitigations systems, whereas some autonomous system may lack threat mitigations systems. As such, systems and methods to redirect DDOS attack using remote mitigation tools are provided.

### CROSS-REFERENCE TO RELATED APPLICATIONS

This application claims the benefit of U.S. Provisional Application No. 63/499,865 filed May 3, 2023, entitled “Systems and Methods to Redirect DDOS Attack Using Remote Mitigation Tools,” which is incorporated herein by reference in its entirety.

### FIELD

One or more aspects of examples according to the present disclosure relate to network systems, and more particularly to systems and methods to redirect DDOS attack using remote mitigation tools.

### BACKGROUND

Distributed denial of service (DDOS) attacks may occur in various networks and may target any of various servers. A DDOS attack on a server in a first autonomous system may be launched from within another autonomous system, or from within the same autonomous system. Some autonomous systems may include threat mitigations systems, whereas some autonomous system may lack threat mitigations systems and/or rely on threat mitigation systems within separate autonomous systems.

It is with respect to this general technical environment that aspects of the present disclosure are related.

### SUMMARY

The presently disclosed technology can permit certain autonomous systems to offload certain computing tasks (such as threat mitigation), when necessary, by packet address modification. In an aspect, the technology relates to a first network device, in a first autonomous system, the first network device comprising at least one processing circuit and memory. The system is configured to receive a packet, comprising a request for a service, from a request source; to modify a source address of the packet to an address of the first network device; to modify a destination address of the packet to an address of a second network device in a second autonomous system, different from the first autonomous system; and to send the packet to the second network device.

In an example, the first network device is configured: to receive a plurality of packets including the packet; and to send the packets, in round-robin fashion, to a plurality of devices in one or more autonomous systems, including the second autonomous system, different from the first autonomous system.

In some examples, the request for a service is a request for a Domain Name Service lookup.

In some examples, the first network device comprises a Domain Name Service server.

In some examples, the modifying of the source address, the modifying of the destination address, and the sending of the packet to the second network device are in response to determining that a load on the first network device has exceeded a threshold.

In some examples, the modifying of the source address, the modifying of the destination address, and the sending of the packet to the second network device are in response to receiving, by the first network device, an indication that an attack on the first network device is in progress.

In some examples, a threat intelligence system configured to send the indication to the first network device.

In some examples, the first network device is further configured to include, in the packet, a packet identifier identifying the packet.

In some examples, the packet identifier is a port number, the port number being part of the source address.

In some examples, the packet identifier is a Domain Name Service transaction identifier.

In some examples, the first network device is further configured: to receive a response to the request from the second network device; and to send the response to the request source.

In some examples, the first network device is further configured, before sending the response to the request source: to modify a source address of the response; and to modify a destination address of the response to an address of the request source.

In some examples, the first network device is further configured: to receive the packet from the second network device; and to send a response to the second network device.

In some examples, the first network device is further configured: to receive the response from the second network device; and to send the response to the request source.

In some examples, the first network device is further configured, before sending the response to the request source: to modify a source address of the response; and to modify a destination address of the response to an address of the request source.

In some examples, the first network device is further configured: to receive the packet from the second network device; and to send a response to the request source.

In another aspect, a method is provided, comprising: receiving, by a first network device, in a first autonomous system, a packet, comprising a request for a service, from a request source; modifying a source address of the packet to an address of the first network device; modifying a destination address of the packet to an address of a second network device in a second autonomous system, different from the first autonomous system; and sending the packet to the second network device.

In some examples, the request for a service is a request for a Domain Name Service lookup.

In another aspect, a system is provided, comprising: a first network device, in a first autonomous system, the first network device comprising at least one processing circuit and memory; and a second network device, in the first autonomous system, the second network device comprising at least one processing circuit and memory. The first network device is configured: to receive a packet, comprising a request for a service, from a third network device in a second autonomous system, different from the first autonomous system; to determine that the packet is clean; and to send the packet to the second network device. Further, the second network device is configured: to receive the packet; and to send the packet to the third network device.

In some examples, the second network device is further configured, before sending the packet to the third network device: to modify a source address of the packet to an address of the second network device; and to modify a destination address of the packet to an address of the third network device.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

These and other features and advantages of the present disclosure will be appreciated and understood with reference to the specification, claims, and appended drawings. The following drawing figures, which form a part of this application, are illustrative of aspects of systems and methods described below and are not meant to limit the scope of the disclosure in any manner, which scope shall be based on the claims.

FIG. 1 is a block diagram of a portion of a network system, according to an example of the present disclosure;

FIG. 2A is a flow chart of a method, according to an example of the present disclosure;

FIG. 2B is a flow chart of a method, according to an example of the present disclosure;

FIG. 2C is a flow chart of a method, according to an example of the present disclosure;

FIG. 2D is a flow chart of a method, according to an example of the present disclosure; and

FIG. 3 is a block diagram of an operating environment, according to an example of the present disclosure.

### DETAILED DESCRIPTION

The detailed description set forth below in connection with the appended drawings is intended as a description of exemplary embodiments of systems and methods to redirect packets, e.g., during a DDOS attack, using remote mitigation tools provided in accordance with the present disclosure and is not intended to represent the only forms in which the present disclosure may be constructed or utilized. The description sets forth the features of the present disclosure in connection with the illustrated examples. It is to be understood, however, that the same or equivalent functions and structures may be accomplished by different examples that are also intended to be encompassed within the scope of the disclosure. As denoted elsewhere herein, like element numbers are intended to indicate like elements or features.

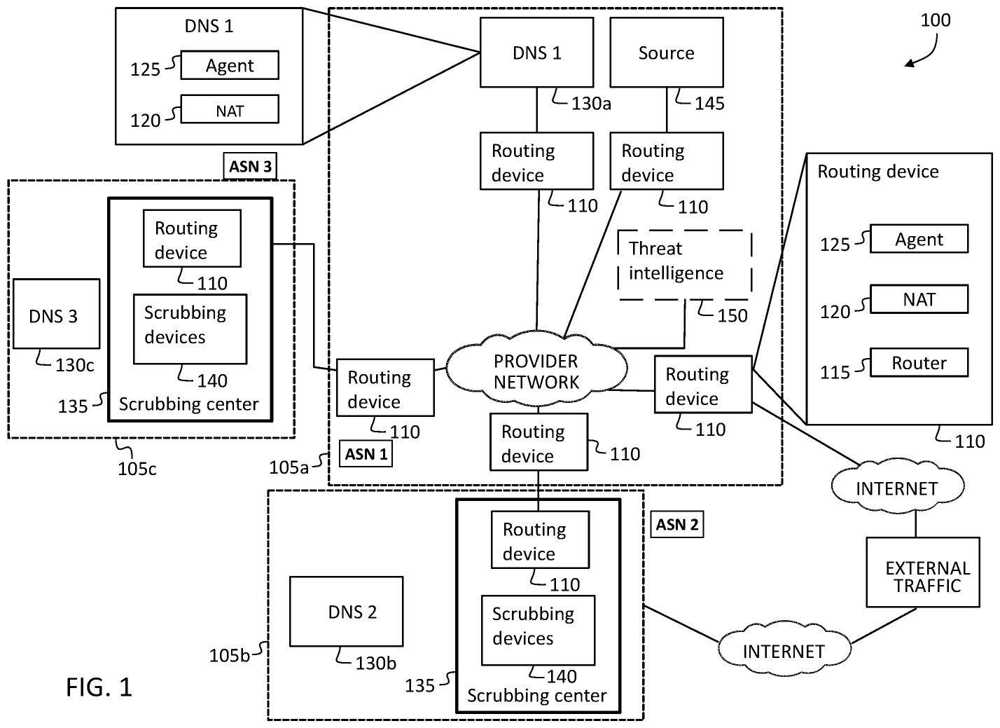

FIG. 1 is a block diagram of an example network system 100. The network system 100 may include several autonomous systems 105, including a first autonomous system 105a, a second autonomous system 105b, and a third autonomous system 105c. Each of the autonomous systems 105 may include one or more routing devices (e.g., switches or routers) 110. Each routing device 110 may include a router 115, a network address translation (NAT) table 120, and an agent 125 running on the routing device 110. Each of the autonomous systems may include one or more network devices, e.g., servers 130 (e.g., a first server 130a in the first autonomous system 105a, a second server 130b in the second autonomous system 105b, and a third server 130c in the third autonomous system 105c), each of which may (i) be a Domain Name System (DNS) server and (ii) include a network address translation (NAT) table 120, and an agent 125 running on the server 130. One or more of the autonomous systems (e.g., the second autonomous system 105b, and the third autonomous system 105c, as illustrated) may include a threat mitigation system, e.g., a scrubbing center 135, which may include network devices such as (i) a routing device 110 and (ii) one or more scrubbing devices 140. Actions ascribed, in the present disclosure to the servers 130 or the routing devices 110, may, in some examples, be performed by the respective agents 125 running on the servers 130 or on the routing devices 110.

As used herein, an autonomous system (AS) may comprise a collection of connected Internet Protocol (IP) networks that is operated by a single entity or organization. The AS may comprise a unit of a larger network, such as the internet, that functions as a single entity and can communicate with other autonomous systems using Border Gateway Protocol (BGP). An AS may be assigned a unique number called an Autonomous System Number (ASN) by a regional Internet registry (RIR) to identify it within the global network. In examples, the ASN is used by BGP to route traffic within and between ASs.

In operation, a request source 145 in the first autonomous system 105a (and possibly other request sources) may send, to the first server 130a, a plurality of packets, each including a request for a service. For example, request source 145 may comprise a client computing device running a browser application, and each of the packets may include a DNS lookup request. In some circumstances, the first server 130a may transition to a mitigation state. For example, the first server 130a may determine that its load has exceeded a threshold (e.g., as a result of a high volume of requests for the service) or a threat intelligence system 150 may determine that an attack on the first server 130a is being conducted, and instruct the first server 130a to transition to the mitigation state. In nonexclusive examples, a threat intelligence system 150 may determine that an attack on the first server 130a is being conducted by analyzing flow information from packets transceived by routing devices 110 directed to, or coming from, server(s) 130. In examples, the threat intelligence system 150 may be hosted within one or more of the first autonomous system 105a, second autonomous system 105b, third autonomous system 105c, or in a different network.

As illustrated, the first autonomous system 105a may lack a threat mitigation system; as such, mitigation options that might be available if the first autonomous system 105a were to contain a threat mitigation system (e.g., using scrubbers to filter packets in the first autonomous system 105a) may be unavailable locally. As such, the first server 130a may take other mitigation actions, in the mitigation state, to reduce its load. For example, upon receiving a packet (e.g., a first packet) from the request source 145, the first server 105a may (instead of processing the first packet (e.g., performing a DNS lookup), generating a response, and sending the response back to the request source 145) forward the first packet to another server, in another autonomous system 105 (e.g., to another server, such as the second server 130b, in an autonomous system with a threat mitigation system (e.g., in the second autonomous system 105b)).

To perform the forwarding, the first server 130a may change the source address (of the first packet) to (i) the Internet Protocol (IP) address of the first server 130a and (ii) a specified port number (discussed in further detail below), and it may change the destination address to (i) the IP address of the second server 130b and (ii) a standard port for receiving requests of the type included in the first packet (e.g., a standard port for receiving DNS lookup requests). The first server 130a may also include, in the first packet, a packet identifier identifying the packet, and it may make an entry in its NAT table 120, the entry including (i) the packet identifier, and (ii) the IP address of the request source 145. The packet identifier may be, e.g., a port number (if the port number that is included as part of the modified source address is not a standard port number for the service) or it may be a different packet identifier, e.g., a Domain Name Service transaction identifier. If a different packet identifier is used, the port number that is included as part of the modified source address may be a standard port number for the service. The NAT table 120 may be employed by the first server 130a to determine, when it receives a response to the first packet from the second server 130b, that the response is a response to the first packet and that the response should therefore be sent to the request source 145. If the first server 130a uses, as the packet identifier, the DNS transaction identifier, then it may (i) use the original DNS transaction identifier included in the packet received from the request source 145, or (ii) use a different transaction identifier, and include the original DNS transaction identifier in the NAT table 120, so that the transaction identifier may be changed back (as discussed in further detail below) when a response is forwarded, by the first server 130a, to the request source 145 (the request source 145 may be configured to reject or ignore responses that do not align with the same transaction identifier and original destination address as the packet's source). In some examples, the second server 130b may respond directly to the request source 145 (the second server 130b changing the source address in doing so). The second autonomous system 105b may be arranged and/or programmed (e.g., by configuration or negotiation) to not drop the response from the second server 130b (which, absent such setting up, might drop the response since the source address, as changed, would not belong to the second autonomous system 105b).

When the packet, and other packets like it, are received by the second autonomous system 105b (e.g., by the threat mitigation system (e.g., the scrubbing center 135) of the second autonomous system 105b) a routing device 110 of the second autonomous system 105b may route the packets to the one or more scrubbing devices 140 of the second autonomous system 105b. The scrubbing devices 140 may drop packets that are filtered out based on an identified threat (e.g., all packets having certain characteristics identified by, e.g., threat intelligence system 150, as characteristics indicating that the packet is part of an attack), and send “clean” packets (that are not identified as part of the attack) to their intended destination (e.g., to the second server 130b). If the first packet is identified as likely part of the attack, it may be dropped by the scrubbing device 140. If the first packet is a clean packet, then it may be forwarded to the second server 130b, which may process it and generate a response to the request (e.g., it may perform a DNS lookup and generate a response to the DNS lookup request) and send the response to the source address of the first packet (e.g., to the IP address of the first server 130a and to the port specified as part of the source address of the first packet). As used herein, unless otherwise specified, “address” means a combination of an Internet Protocol (IP) address and a port.

The response may include the packet identifier (e.g., when generating a response to a DNS lookup request, the second server 130b may include the DNS transaction identifier in the response, and the second server 130b may send the response to the port number that is included as part of the modified source address). The first server 130a may then receive the first packet, match it with an entry in its NAT table 120 (based on the packet identifier included in the response (e.g., as a port number or as a transaction identifier)), determine, based on the NAT table entry that the response is a response to a request received from the request source 145, and send the response to the request source 145. If the first server 130a changed the DNS transaction identifier when it forwarded the first packet to the second server 130b, then the first server 130a may change the DNS transaction identifier back to its original value (e.g., based on the NAT table 120 of the first server 130a) before sending the response to the request source 145.

In some examples, when the first server 130a is in the mitigation state, it may send the packets it receives, (or a fraction of such packets, sufficient to reduce its load significantly) to a plurality of other servers, e.g., in a round-robin fashion. This approach may avoid a situation in which, for example, the first server 130a is overwhelmed as a result of an attack, and, in response, the first server 130a begins forwarding each packet it receives to the second server 130b, which then becomes overwhelmed by the high volume of packets forwarded by the first server 130a. For example, the scrubbing devices 140 may not immediately be configured to recognize packets that are part of an attack, so a large number of packets may make it through to the second server 130b before the scrubbing devices 140 can mitigate the attack.

In some examples, the first server 130a may periodically obtain (e.g., upon request) from the scrubbing device 140, a list of dropped packets (e.g., a list of packet identifiers of dropped packets), and, upon receipt of such a list, the first server 130a may delete the corresponding entries from its NAT table 120, thereby freeing the corresponding memory in the first server 130a. That is, the first server 130a need not keep track in its NAT table 120 of forwarded packets that were eventually dropped, as no corresponding response will be received.

In some circumstances, it may be that the response the first server 130a would give in response to a DNS lookup request is different from the response the second server 130b would give in response to the same DNS lookup request (e.g., as a result of geo-targeting rules). A service for which content of the response is affected by location of the requesting device (such as a DNS lookup) or by the location of the server 130 relative to the requesting device may be referred to as a “localized” service. In such a situation, it may be that sending, by the first server 130a, the first packet to the second server 130b, and forwarding, by the first server 130a, a response generated by the second server 130b to the request source 145 may result in the request source 145 receiving an inappropriate response (e.g., a DNS lookup result that is an address of a server that is needlessly distant from the request source 145).

In such a situation, the second server 130b may be configured to determine, when it receives the first packet, that the first packet includes a request, from another AS, for a localized service, and the second server 130b may (i) change the source address of the first packet to the address of the second server 130b, (ii) change the destination address of the first packet to the address of the first server 130a, (iii) change the packet identifier, and (iv) send the first packet back to the first server 130a. The first server 130a may then process the first packet, and generate a response, and it may send the response back to the second server 130b. The second server 130b may change the packet identifier back to the original packet identifier received from the first server 130a, and then send the response to the first server 130a, for forwarding to the request source 145. Upon receipt of the response, the first server 130a may (i) determine, from the packet identifier (and from the NAT table 120 of the first server 130a) that the response is a response to the first packet, (ii) change the source address of the response to the address of the first server 130a, (iii) change the destination address of the response to the address of the request source 145, and (iv) send the response to the request source 145.

In this process, the second server 130b may be configured to send the first packet back to the first server 130a based on the type of service requested (e.g., a localized service such as a DNS lookup), and based on the first server 130a being in a different AS from the second server 130b (the second server 130b may also be configured to instead generate a response, when it receives a request for the same type of service in a packet from a server in the same AS).

In some examples, instead of the first server 130a sending the response back to the second server 130b, the first server 130a may send the response directly to the request source 145. In such an example, the second server 130b, upon determining that the first packet includes a request, from another AS, for a localized service, may send the first packet to the first server 130a without changing the packet identifier. In this situation, the first server 130a may recognize (based on the packet identifier (and based on the NAT table 120 of the first server 130a)) the received packet as being the first packet, and it may generate a response and send the response directly to the request source 145. In this way, the response is localized without multiple round trips between the first server 130a and second server 130b.

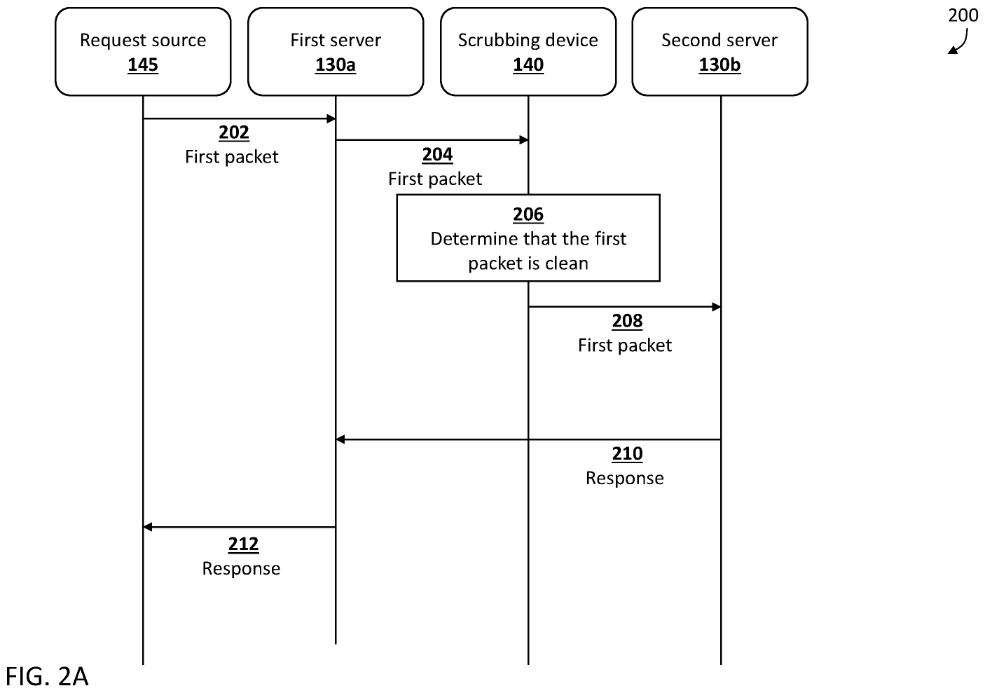

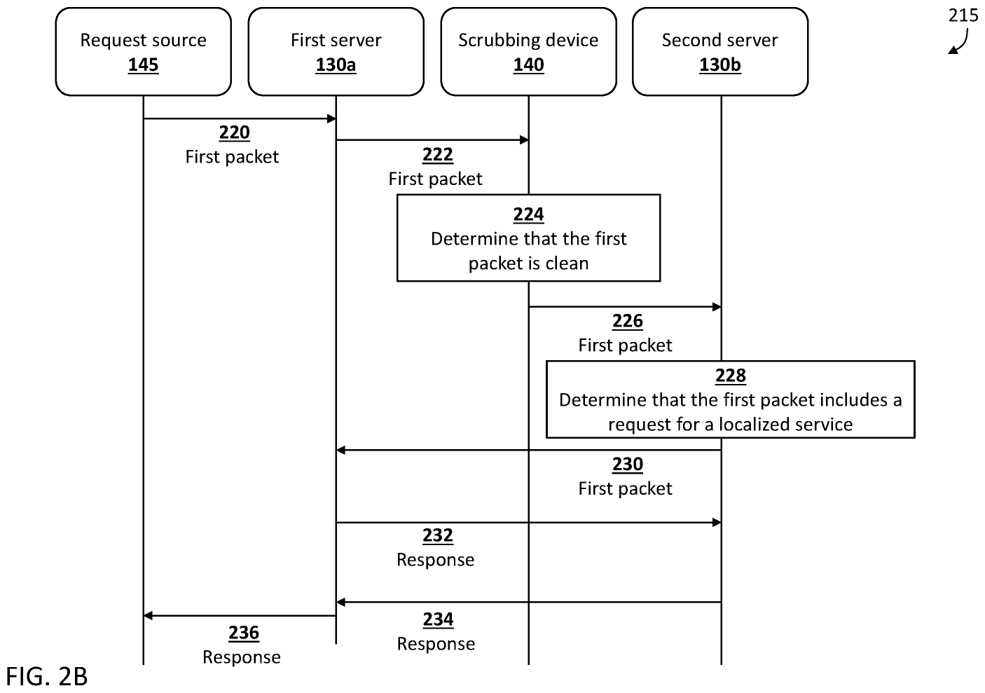

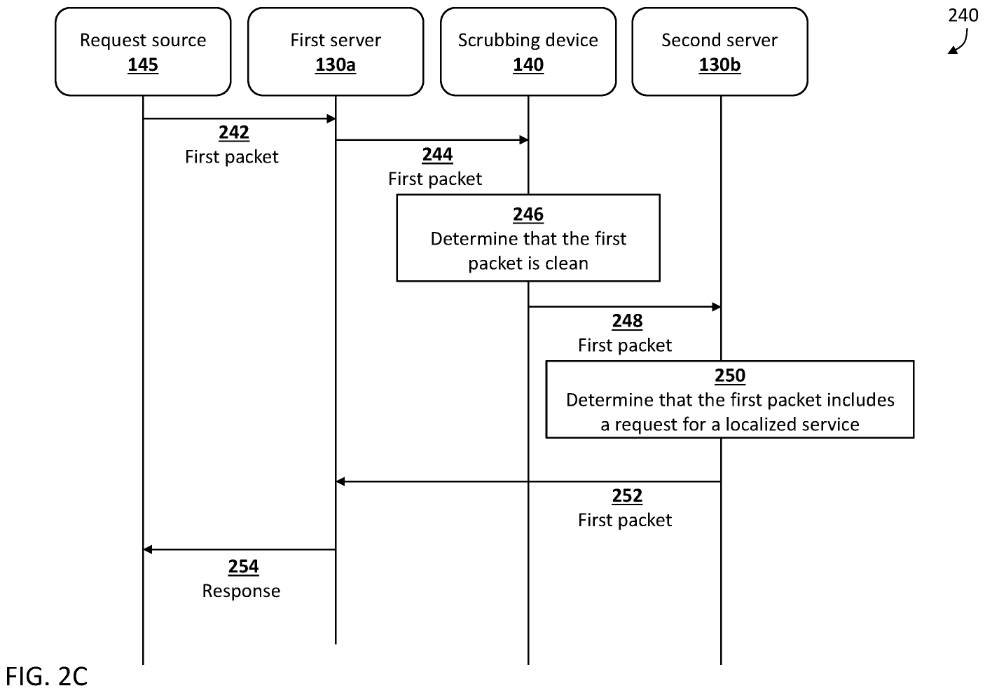

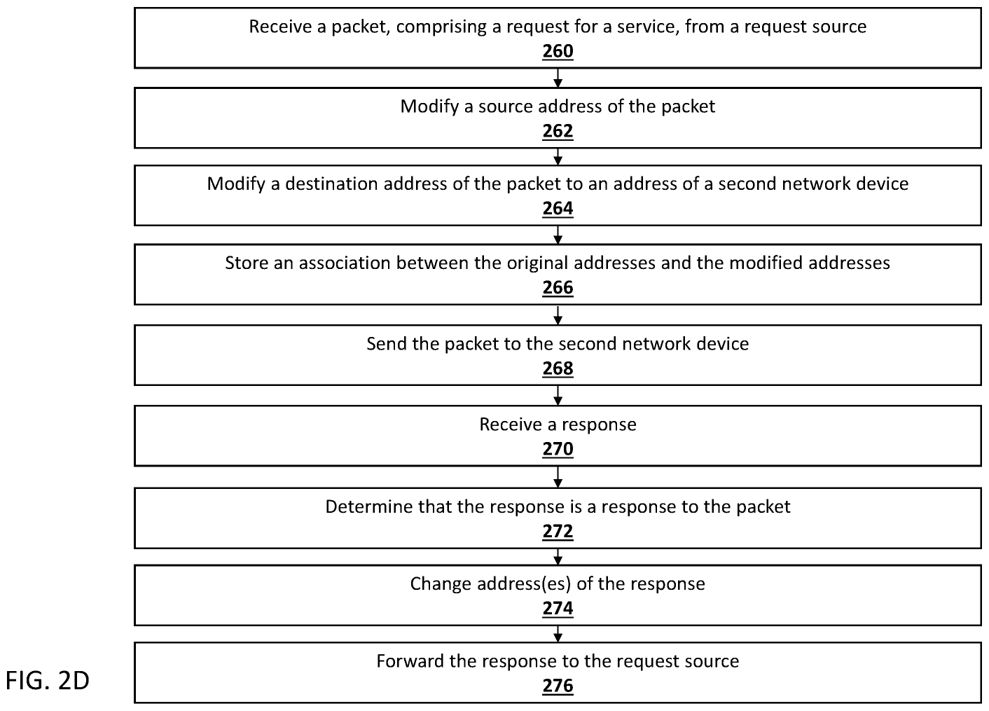

FIG. 2A depicts a first example method 200 in which aspects of the present technology may be practiced by the request source 145, the first server 130a, the scrubbing device 140, and the second server 130b. As discussed, in examples, at 202, the request source 145 sends a first packet to the first server 130a, which (e.g., because it is in the mitigation state) sends the first packet to the second server 130b. As mentioned above, as part of this process the first server 130a may change the source address to (i) the Internet Protocol (IP) address of the first server 130a and (ii) a specified port number, and it may change the destination address to (i) the IP address of the second server 130b and (ii) a standard port for receiving requests of the type included in the first packet (e.g., a standard port for receiving DNS lookup requests). The first server 130a may store an association between the original address(es) and the modified address(es) in the NAT table 120. The first packet may be transmitted, at 204, to the scrubbing device 140, where it is, at 206, determined to be clean, and transmitted, at 208, to the second server 130b. The second server 130b may then generate a response, and, at 210, send the response to the first server 130a. The first server 130a may then determine, from the association stored in the NAT table 120, that the response is a response to the previously forwarded first packet from the request source 145, and forward the response, at 212, to the request source 145.

FIG. 2B depicts a second example method 215 in which aspects of the present technology may be practiced by the request source 145, the first server 130a, the scrubbing device 140, and the second server 130b. As discussed, in examples, at 220, the request source 145 sends a first packet to the first server 130a, which (e.g., because it is in the mitigation state) sends the first packet to the second server 130b. As mentioned above, as part of this process the first server 130a may change the source address to (i) the Internet Protocol (IP) address of the first server 130a and (ii) a specified port number, and it may change the destination address to (i) the IP address of the second server 130b and (ii) a standard port for receiving requests of the type included in the first packet (e.g., a standard port for receiving DNS lookup requests). The first packet may be transmitted, at 222, to the scrubbing device 140, where it is, at 224, determined to be clean, and transmitted, at 226, to the second server 130b.

As mentioned above, the second server 130b may, at 228, determine, when it receives the first packet, that the first packet includes a request, from another AS, for a localized service, and the second server 130b may (i) change the source address of the first packet to the address of the second server 130b, (ii) change the destination address of the first packet to the address of the first server 130a, (iii) change the packet identifier, and (iii) send, at 230, the first packet back to the first server 130a. The first server 130a may then process the first packet, and generate a response, and it may, at 232, send the response back to the second server 130b. The second server 130b may change the packet identifier back, and then, at 234, send the response to the first server 130a, for forwarding to the request source 145. Upon receipt of the response, the first server 130a may (i) determine, from the packet identifier (and from the NAT table 120 of the first server 130a) that the response is a response to the first packet, (ii) change the source address of the response to the address of the first server 130a, (iii) change the destination address of the response to the address of the request source 145, and (iv) at 236, send the response to the request source 145.

FIG. 2C depicts a third example method 240 in which aspects of the present technology may be practiced by the request source 145, the first server 130a, the scrubbing device 140, and the second server 130b. As discussed, in examples, at 242, the request source 145 sends a first packet to the first server 130a, which (e.g., because it is in the mitigation state) sends the first packet to the second server 130b. As mentioned above, as part of this process the first server 130a may change the source address to (i) the Internet Protocol (IP) address of the first server 130a and (ii) a specified port number, and it may change the destination address to (i) the IP address of the second server 130b and (ii) a standard port for receiving requests of the type included in the first packet (e.g., a standard port for receiving DNS lookup requests). The first packet may be transmitted, at 244, to the scrubbing device 140, where it is, at 246, determined to be clean, and transmitted, at 248, to the second server 130b.

At 250, the second server 130b determines that the first packet includes a request, from another AS, for a localized service. The second server 130b may then (i) change the source address of the first packet to the address of the second server 130b, (ii) change the destination address of the first packet to the address of the first server 130a, and (iv) send, at 252, the first packet back to the first server 130a (without changing the packet identifier). The first server 130a may recognize (based on the packet identifier (and based on the NAT table 120 of the first server 130a)) the received packet as being the first packet, and it may generate a response and send the response, at 254, directly to the request source 145.

FIG. 2D depicts a flow chart of a method. In some examples, the method includes receiving, at 260, by a first network device (e.g., by the first server 130a) a packet, comprising a request for a service, from a request source 145. The request for a service may be, for example, a DNS lookup request. The request source 145 may be a client, under the control of a malicious actor, participating in an attack on the first server 130a or the request source 145 may be a legitimate client making a legitimate request for the service.

The method may further include modifying, at 262, a source address of the packet. For example, the first server 130a may replace the source address (which originally may be the address of the request source 145) with the address of the first server 130a.

The method may further include modifying, at 264, a destination address of the packet to an address of a second network device. For example, the original destination address may be an address of the first server 130a, and the first server 130a may replace this original address with an address of a second network device, e.g., with an address of the second server 130b.

The method may further include storing, at 266, an association between the original address(es) and the modified address(es) in the NAT table 120. This association may be used to recognize responses, as discussed in further detail below.

The method may further include sending, at 268, the packet to a second network device. The first network device (e.g., the first server 130a) may be in a first autonomous system 105a, lacking a threat mitigation system, and the second network device (e.g., the second server 130b) may be in a second autonomous system 105b, different from the first autonomous system 105a. The second autonomous system 105b may have a threat mitigation system. As such, sending the packet to the second network device may cause the packet to be processed by a threat mitigation system.

The method may further include receiving, at 270, a response from the second network device. The second network device may have received the packet after processing by the threat mitigation system (e.g., after scrubbing, by a scrubbing device 140), and it may have generated the response and sent it to the first network device.

The method may further include determining, at 272, that the response is a response to the previously forwarded first packet from the request source 145. The determining may be based on the association stored in the NAT table 120.

The method may further include changing, at 274, address(es) of the response. This may involve changing the source address of the response to the address of the first network device and changing the destination address of the response to the address of the request source 145.

The method may further include forwarding the response, at 276, to the request source 145. This forwarding may have the effect of providing, to the request source 145, the response it had requested.

In some examples, one or more of the actions ascribed herein to the first server 130a (except for the generating of a response) may instead be performed by a routing device 110 connected (i) between the request source 145 and the first server 130a and (ii) between the first server 130a and the second server 130b. For example, such a routing device 110 may redirect the first packet to the second server 130b (changing the source and destination addresses as described above), and it may also forward a response received from the second server 130b to the request source 145 (after changing the source and destination addresses as described above).

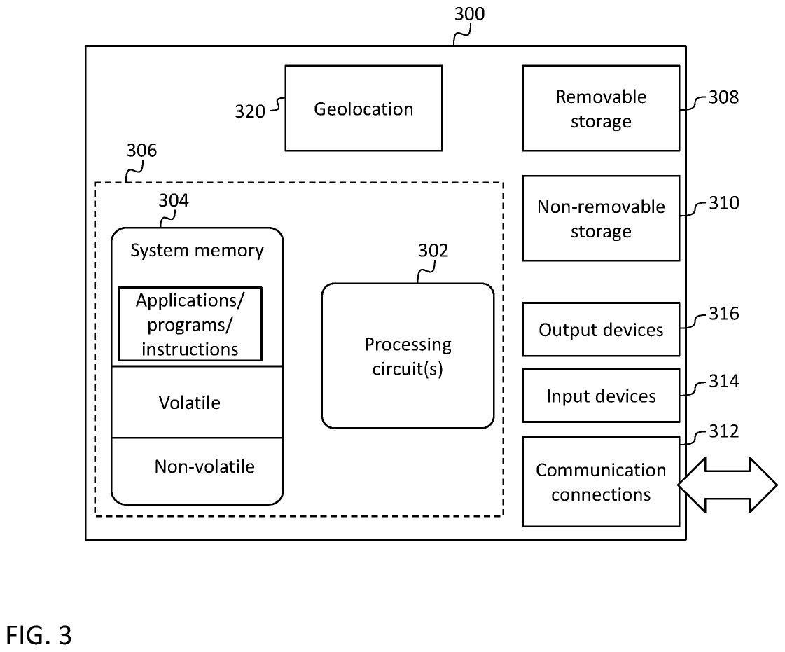

FIG. 3 depicts an example of a suitable operating environment 300, portions of which may be used to implement each of the servers 110, each of the routing devices, each of the scrubbing devices 140, or other devices that may include computing functionality within the systems discussed herein. In its most basic configuration, operating environment 300 typically includes at least one processing circuit 302 and memory 304. The processing circuit may be a processor, which is hardware. Depending on the exact configuration and type of computing device, memory 304 (storing instructions to perform the methods disclosed herein) may be volatile (such as RAM), non-volatile (such as ROM, flash memory, etc.), or some combination of the two. This most basic configuration is illustrated in FIG. 3 by dashed line 306. The memory 304 stores instructions that, when executed by the processing circuit(s) 302, perform the processes and operations described herein. Further, environment 300 may also include storage (removable 308, or non-removable 310) including, but not limited to, solid-state, magnetic disks, optical disks, or tape. Similarly, environment 300 may also have input device(s) 314 such as keyboard, mouse, pen, voice input, etc., or output device(s) 316 such as a display, speakers, printer, etc. Additional communication connections 312 may also be included that allow for further communication with LAN, WAN, point-to-point, etc. Operating environment 300 may also include geolocation devices 320, such as a global positioning system (GPS) device.

Operating environment 300 typically includes at least some form of computer readable media. Computer readable media can be any available media that can be accessed by processing circuit 302 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of any of the above should also be included within the scope of computer readable media.

The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As will be understood from the foregoing disclosure, many technical advantages and improvements result from the present technology. For instance, the present technology provides for significant improvement in computing resources associated with mitigating denial of service attacks or other threats. In non-exclusive examples, present systems and methods may allow autonomous systems that, themselves, lack the hardware or computing capabilities (such as packet scrubbing to mitigate DDOS attacks or other threats), to elegantly offload certain requests for service to autonomous systems that do have such capabilities. In examples, such systems and methods may save computing resources by not requiring all autonomous systems to have computing capabilities that are needed only under certain conditions, among other potential technical improvements.

In an aspect, the technology relates to a first network device, in a first autonomous system, the first network device comprising at least one processing circuit and memory. The system is configured to receive a packet, comprising a request for a service, from a request source; to modify a source address of the packet to an address of the first network device; to modify a destination address of the packet to an address of a second network device in a second autonomous system, different from the first autonomous system; and to send the packet to the second network device.

In an example, the first network device is configured: to receive a plurality of packets including the packet; and to send the packets, in round-robin fashion, to a plurality of devices in one or more autonomous systems, including the second autonomous system, different from the first autonomous system.

In some examples, the request for a service is a request for a Domain Name Service lookup.

In some examples, the first network device comprises a Domain Name Service server.

In some examples, the modifying of the source address, the modifying of the destination address, and the sending of the packet to the second network device are in response to determining that a load on the first network device has exceeded a threshold.

In some examples, the modifying of the source address, the modifying of the destination address, and the sending of the packet to the second network device are in response to receiving, by the first network device, an indication that an attack on the first network device is in progress.

In some examples, a threat intelligence system configured to send the indication to the first network device.

In some examples, the first network device is further configured to include, in the packet, a packet identifier identifying the packet.

In some examples, the packet identifier is a port number, the port number being part of the source address.

In some examples, the packet identifier is a Domain Name Service transaction identifier.

In some examples, the first network device is further configured: to receive a response to the request from the second network device; and to send the response to the request source.

In some examples, the first network device is further configured, before sending the response to the request source: to modify a source address of the response; and to modify a destination address of the response to an address of the request source.

In some examples, the first network device is further configured: to receive the packet from the second network device; and to send a response to the second network device.

In some examples, the first network device is further configured: to receive the response from the second network device; and to send the response to the request source.

In some examples, the first network device is further configured, before sending the response to the request source: to modify a source address of the response; and to modify a destination address of the response to an address of the request source.

In some examples, the first network device is further configured: to receive the packet from the second network device; and to send a response to the request source.

In another aspect, a method is provided, comprising: receiving, by a first network device, in a first autonomous system, a packet, comprising a request for a service, from a request source; modifying a source address of the packet; modifying a destination address of the packet to an address of a second network device in a second autonomous system, different from the first autonomous system; and sending the packet to the second network device.

In some examples, the request for a service is a request for a Domain Name Service lookup.

In another aspect, a system is provided, comprising: a first network device, in a first autonomous system, the first network device comprising at least one processing circuit and memory; and a second network device, in the first autonomous system, the second network device comprising at least one processing circuit and memory. The first network device is configured: to receive a packet, comprising a request for a service, from a third network device in a second autonomous system, different from the first autonomous system; to determine that the packet is clean; and to send the packet to the second network device. Further, the second network device is configured: to receive the packet; and to send the packet to the third network device.

In some examples, the second network device is further configured, before sending the packet to the third network device: to modify a source address of the packet to an address of the second network device; and to modify a destination address of the packet to an address of the third network device.

Those skilled in the art will recognize that the methods and systems of the present disclosure may be implemented in many manners and as such are not to be limited by the foregoing aspects and examples. In other words, functional elements being performed by a single or multiple components. In this regard, any number of the features of the different aspects described herein may be combined into single or multiple aspects, and alternate aspects having fewer than or more than all of the features herein described are possible. Functionality may also be, in whole or in part, distributed among multiple components, in manners now known or to become known.

Although exemplary embodiments of systems and methods have been specifically described and illustrated herein, many modifications and variations will be apparent to those skilled in the art. Accordingly, it is to be understood that systems and methods constructed according to principles of this disclosure may be embodied other than as specifically described herein. The invention is also defined in the following claims, and equivalents thereof.

What is claimed is:

1. A system, comprising:
a first network device, in a first autonomous system, the first network device comprising at least one processing circuit and memory, and being configured:
to receive a packet, comprising a request for a service, from a request source;
to modify a source address of the packet to an address of the first network device;
to modify a destination address of the packet to an address of a second network device in a second autonomous system, different from the first autonomous system; and
to send the packet to the second network device.

2. The system of claim 1, wherein the first network device is configured:
to receive a plurality of packets including the packet; and
to send the packets, in round-robin fashion, to a plurality of devices in one or more autonomous systems, including the second autonomous system, different from the first autonomous system.

3. The system of claim 1, wherein the request for a service is a request for a Domain Name Service lookup.

4. The system of claim 3, wherein the first network device comprises a Domain Name Service server.

5. The system of claim 1, wherein the modifying of the source address, the modifying of the destination address, and the sending of the packet to the second network device are in response to determining that a load on the first network device has exceeded a threshold.

6. The system of claim 1, wherein the modifying of the source address, the modifying of the destination address, and the sending of the packet to the second network device are in response to receiving, by the first network device, an indication that an attack on the first network device is in progress.

7. The system of claim 6, further comprising a threat intelligence system configured to send the indication to the first network device.

8. The system of claim 1, wherein the first network device is further configured to include, in the packet, a packet identifier identifying the packet.

9. The system of claim 8, wherein the packet identifier is a port number, the port number being part of the source address.

10. The system of claim 8, wherein the packet identifier is a Domain Name Service transaction identifier.

11. The system of claim 1, wherein the first network device is further configured:
to receive a response to the request from the second network device; and
to send the response to the request source.

12. The system of claim 11, wherein the first network device is further configured, before sending the response to the request source:
to modify a source address of the response; and
to modify a destination address of the response to an address of the request source.

13. The system of claim 1, wherein the first network device is further configured:
to receive the packet from the second network device; and
to send a response to the second network device.

14. The system of claim 13, wherein the first network device is further configured:
to receive the response from the second network device; and
to send the response to the request source.

15. The system of claim 14, wherein the first network device is further configured, before sending the response to the request source:
to modify a source address of the response; and
to modify a destination address of the response to an address of the request source.

16. The system of claim 1, wherein the first network device is further configured:
to receive the packet from the second network device; and
to send a response to the request source.

17. A method, comprising:
receiving, by a first network device, in a first autonomous system, a packet, comprising a request for a service, from a request source;
modifying a source address of the packet to an address of the first network device;
modifying a destination address of the packet to an address of a second network device in a second autonomous system, different from the first autonomous system; and
sending the packet to the second network device.

18. The method of claim 17, wherein the request for a service is a request for a Domain Name Service lookup.

19. A system, comprising:
a first network device, in a first autonomous system, the first network device comprising at least one processing circuit and memory; and
a second network device, in the first autonomous system, the second network device comprising at least one processing circuit and memory,
the first network device being configured:
to receive a packet, comprising a request for a service, from a third network device in a second autonomous system, different from the first autonomous system;
to determine that the packet is clean; and
to send the packet to the second network device,
the second network device being configured:
to receive the packet; and
to send the packet to the third network device.

20. The system of claim 19, wherein the second network device is further configured, before sending the packet to the third network device:
to modify a source address of the packet to an address of the second network device; and
to modify a destination address of the packet to an address of the third network device.
